(19) United States
(12) Patent Application Publication
(10) Pub. No.: US 2026/0369141 A1
(43) Pub. Date: Nov. 19, 2026

(54) EVENT PATTERN RECOGNITION

(71) Applicant: Vivint LLC, Provo, UT (US)

(72) Inventors: Kishore Penumuru, Provo, UT (US); Nathan Maus, Provo, UT (US); Justin Tran, Provo, UT (US); Christopher Hall, Provo, UT (US)

(73) Assignee: Vivint LLC, Provo, UT (US)

(21) Appl. No.: 19/676,939

(22) Filed: May 14, 2026

Related U.S. Application Data
(60) Provisional application No. 63/805,942, filed on May 14, 2025.

(51) Int. Cl. G08B 13/196

(52) U.S. Cl. CPC G08B 13/19613

(57) ABSTRACT

A method may compare data associated with recorded events. A method may identify a pattern in the data. A method may generate a notification based on the identified pattern. A method may monitor data subsequent to identification of the pattern. A method may generate an alert based on the monitored data and the identified pattern.

### CROSS REFERENCE

This application claims priority to United States Provisional Patent Application, 63/805,942, filed May 14, 2025, and entitled EVENT PATTERN RECOGNITION, which is incorporated by reference herein in its entirety.

### TECHNICAL FIELD

The current disclosure generally relates to smart home security systems.

### BACKGROUND

Alarm systems are used to detect emergencies or other situations and to alert a user and/or a monitoring service. Monitoring services are generally used to support users of alarms to coordinate with police, emergency (e.g., medical), fire, and/or otherwise.

### SUMMARY

To overcome one or more shortcomings of alarm systems, data management in alarm systems, and monitoring services, a method is presented. In one embodiment, the method may include comparing data associated with recorded events, identifying a pattern in the data, generating a notification based on the identified pattern, monitoring data subsequent to identification of the pattern, and generating an alert based on the monitored data and the identified pattern.

### BRIEF DESCRIPTION OF THE FIGURES

A more complete understanding of the method and apparatus of the present invention may be obtained by reference to the following Detailed Description when taken in conjunction with the accompanying figures wherein:

FIG. 1 is a perspective view illustrating one embodiment of a security system inclusive of smart locks, according to an embodiment;

FIG. 2 is a network environment including an alarm system;

FIG. 3 is a block diagram of vector processing;

FIG. 4 is a block diagram of sampling logic;

FIG. 5 is a logic diagram for upload candidate selection; and

FIG. 6 is a logic diagram for selected candidate upload; and

FIG. 7 is a flow diagram for pattern identification and notification.

### DETAILED DESCRIPTION

Before turning to the figures, which illustrate certain illustrative embodiments in detail, it should be understood that the present disclosure is not limited to the details or methodology set forth in the description or illustrated in the figures. It should also be understood that the terminology used herein is for the purpose of description only and should not be regarded as limiting.

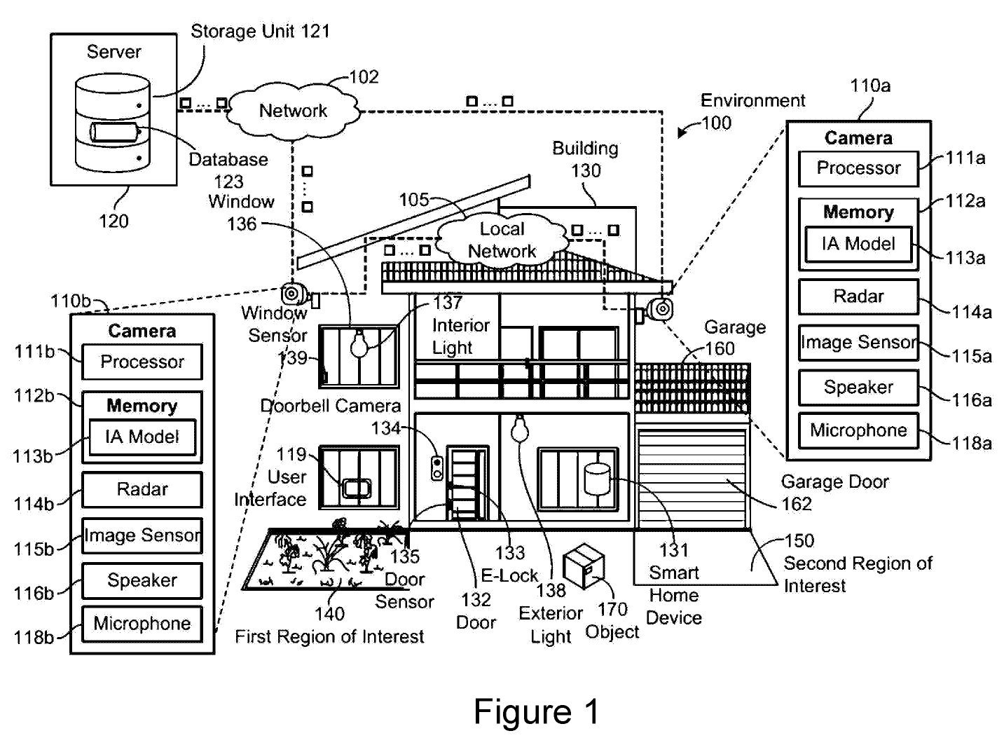

FIG. 1 illustrates an example environment 100, such as a residential property, in which the present systems and methods may be implemented. The environment 100 may include a site that can include one or more structures, any of which can be a structure or building 130, such as a home, office, warehouse, garage, and/or the like. The building 130 may include various entryways, such as one or more doors 132, one or more windows 136, and/or a garage 160 having a garage door 162. The environment 100 may include multiple sites. In some implementations, the environment 100 includes multiple sites, each corresponding to a different property and/or building. In an example, the environment 100 may be a cul-de-sac that includes multiple buildings 130.

The building 130 may include a security system 101 or one or more security devices that are configured to detect and mitigate crime and property theft and damage by alerting a trespasser or intruder that their presence is known while optionally alerting a monitoring service about detecting a trespasser or intruder (e.g., burglar). The security system 101 may include a variety of hardware components and software modules or programs configured to monitor and protect the environment 100 and one or more buildings 130 located thereat. In an embodiment, the security system 101 may include one or more sensors (e.g., cameras, microphones, vibration sensors, pressure sensors, motion detectors, proximity sensors (e.g., door or window sensors), range sensors, etc.), lights, speakers, and optionally one or more controllers (e.g., hub) at the building 130 in which the security system 101 is installed. In an embodiment, the cameras, sensors, lights, speakers, and/or other devices may be smart by including one or more processors therewith to be able to process sensed information (e.g., images, sounds, motion, etc.) so that decisions may be made by the processor(s) as to whether the captured information is associated with a security risk or otherwise.

The sensor(s) of the security system 101 may be used to detect a presence of a trespasser or intruder of the environment (e.g., outside, inside, above, or below the environment) such that the sensor(s) may automatically send a communication to the controller(s). The communication may occur whether or not the security system 101 is armed, but if armed, the controller(s) may initiate a different action than if not armed. For example, if the security system 101 is not armed when an entity is detected, then the controller(s) may simply record that a detection of an entity occurred without sending a communication to a monitoring service or taking local action (e.g., outputting an alert or other alarm audio signal) and optionally notify a user via a mobile app or other communication method of the detection of the entity. If the security system 101 is armed when a detection of an entity is made, then the controller(s) may initiate a disarm countdown timer (e.g., 60 seconds) to enable a user to disarm the security system 101 via a controller, mobile app, or otherwise, and, in response to the security system 101 not being disarmed (or being accepted by a user prior to completion of the countdown timer), communicate a notification including detection information (e.g., image, sensor type, sensor location, etc.) to a monitoring service (optionally after giving a user a chance to disarm the security system 101), which may, in turn, notify public authorities, such as police, to dispatch a unit to the environment 100, initiate an alarm (e.g., output an audible signal) local to the environment 100, communicate a message to a user via a mobile app or other communication (e.g., text message), or otherwise.

In the event that the security system 101 is armed and detects a trespasser or intruder, then the security system 101 may be configured to generate and communicate a message to a monitoring service of the security system 101. The monitoring service may be a third-party monitoring service (i.e., a service that is not the provider of the security system 101). The message may include a number of parameters, such as location of the environment 100, type of sensor, location of the sensor, image(s) if received, and any other information received with the message. It should be understood that the message may utilize any communications protocol for communicating information from the security service to the monitoring service. The message and data contained therein may be used to populate a template on a user interface of the monitoring service such that an operator at the monitoring service may view the data to assess a situation. In an embodiment, a user of the security system 101 may be able to provide additional information that may also be populated on the user interface for an operator in determining whether to contact the authorities to initiate a dispatch. The monitoring service may utilize a standard procedure in response to receiving the message in communicating with a user of the security service and/or dispatching the authorities.

A first camera 110a and a second camera 110b, referred to herein collectively as cameras 110, may be disposed at the environment 100, such as outside and/or inside the building 130. The cameras 110 may be attached to the building 130, such as at a front door of the building 130 or inside of a living room. The cameras 110 may communicate with each other over a local network 105. The cameras 110 may communicate with a server 120 over a network 102. The local network 105 and/or the network 102, in some implementations, may each include a digital communication network that transmits digital communications. The local network 105 and/or the network 102 may each include a wireless network, such as a wireless cellular network, a local wireless network, such as a Wi-Fi network, a Bluetooth® network, a near-field communication (“NFC”) network, an ad hoc network, and/or the like. The local network 105 and/or the network 102 may each include a wide area network (“WAN”), a storage area network (“SAN”), a local area network (“LAN”) (e.g., a home network), an optical fiber network, the internet, or other digital communication network. The local network 105 and/or the network 102 may each include two or more networks. The network 102 may include one or more servers, routers, switches, and/or other networking equipment. The local network 105 and/or the network 102 may also include one or more computer readable storage media, such as a hard disk drive, an optical drive, non-volatile memory, RAM, or the like.

The local network 105 and/or the network 102 may be a mobile telephone network. The local network 105 and/or the network 102 may employ a Wi-Fi network based on any one of the Institute of Electrical and Electronics Engineers (“IEEE”) 802.11 standards. The local network 105 and/or the network 102 may employ Bluetooth® connectivity and may include one or more Bluetooth connections. The local network 105 and/or the network 102 may employ Radio Frequency Identification (“RFID”) communications, including RFID standards established by the International Organization for Standardization (“ISO”), the International Electrotechnical Commission (“IEC”), the American Society for Testing and Materials® (ASTM®), the DASH7™ Alliance, and/or EPCGlobal™.

In some implementations, the local network 105 and/or the network 102 may employ ZigBee® connectivity based on the IEEE 802 standard and may include one or more ZigBee connections. The local network 105 and/or the network 102 may include a ZigBee® bridge. In some implementations, the local network 105 and/or the network 102 employs Z-Wave® connectivity as designed by Sigma Designs® and may include one or more Z-Wave connections. The local network 105 and/or the network 102 may employ an ANT® and/or ANT+® connectivity as defined by Dynastream® Innovations Inc. of Cochrane, Canada and may include one or more ANT connections and/or ANT+ connections.

The first camera 110a may include an image sensor 115a, a processor 111a, a memory 112a, a radar sensor 114a, a speaker 116a, and a microphone 118a. The memory 112a may include computer-readable, non-transitory instructions which, when executed by the processor 111a, cause the processor 111a to perform methods and operations discussed herein. The processor 111a may include one or more processors. The second camera 110b may include an image sensor 115b, a processor 111b, a memory 112b, a radar sensor 114b, a speaker 116b, and a microphone 118b. The memory 112b may include computer-readable, non-transitory instructions which, when executed by the processor 111b, cause the processor to perform methods and operations discussed herein. The processor 111a may include one or more processors.

The memory 112a may include an AI model 113a. The AI model 113a may be applied to or otherwise process data from the camera 110a, the radar sensor 114a, and/or the microphone 118a to detect and/or identify one or more objects (e.g., people, animals, vehicles, shipping packages or other deliveries, or the like), one or more events (e.g., arrivals, departures, weather conditions, crimes, property damage, or the like), and/or other conditions. For example, the cameras 110 may determine a likelihood that an object 170, such as a package, vehicle, person, or animal, is within an area (e.g., a geographic area, a property, a room, a field of view of the first camera 110a, a field of view of the second camera 110b, a field of view of another sensor, or the like) based on data from the first camera 110a, the second camera 110b, and/or other sensors.

The memory 112b of the second camera 110b may include an AI model 113b. The AI model 113b may be similar to the AI model 113a. In some implementations, the AI model 113a and the AI model 113b have the same parameters. In some implementations, the AI model 113a and the AI model 113b are trained together using data from the cameras 110. In some implementations, the AI model 113a and the AI model 113b are initially the same but are independently trained by the first camera 110a and the second camera 110b, respectively. For example, the first camera 110a may be focused on a porch and the second camera 110b may be focused on a driveway, causing data collected by the first camera 110a and the second camera 110b to be different, leading to different training inputs for the first AI model 113a and the second AI model 113b. In some implementations, the AI models 113 are trained using data from one or more storage units 121 (e.g., distributed, centralized, etc.) of the server 120. In an example, the AI models 113 are trained using data collected from a plurality of cameras associated with a plurality of buildings. The cameras 110 may share data with the server 120 for training the AI models 113 and/or a plurality of other AI models. The AI models 113 may be trained using both data from the server 120 and data from their respective cameras.

The cameras 110, in some implementations, may determine a likelihood that the object 170 (e.g., a package) is within an area (e.g., a portion of a site or of the environment 100) based at least in part on audio data from microphones 118, using sound analytics and/or the AI models 113. In some implementations, the cameras 110 may determine a likelihood that the object 170 is within an area based at least in part on image data using image processing, image detection, and/or the AI models 113. The cameras 110 may determine a likelihood that an object is within an area based at least in part on depth data from the radar sensors 114, a direct or indirect time of flight sensor, an infrared sensor, a structured light sensor, or other sensor. For example, the cameras 110 may determine a location for an object, a speed of an object, a proximity of an object to another object and/or location, an interaction of an object (e.g., touching and/or approaching another object or location, touching a car/automobile or other vehicle, touching or opening a mailbox, leaving a package, leaving a car door open, leaving a car running, touching a package, picking up a package, or the like), and/or another determination based at least in part on depth data from the radar sensors 114.

The sensors, such as cameras 110, radar sensors 114, microphones 118, door sensors, window sensors, or other sensors, may be configured to detect a breach of security event for which the respective sensors are configured. For example, the microphones 118 may be configured to sense sounds, such as voices, broken glass, door knocking, or otherwise, and an audio processing system may be configured to process the audio so as to determine whether the captured audio signals are indicative of a trespasser or potential intruder of the environment 100 or building 130. Each of the signals generated or captured by the different sensors may be processed so as to determine whether the sounds are indicative of a security risk or not, and the determination may be time and/or situation dependent. For example, responses to sounds made when the security system 101 is armed may be different to responses to sounds when the security system 101 is unarmed.

A user interface 119 may be installed or otherwise located at the building 130. The user interface 119 may be part of or executed by a device, such as a mobile phone, a tablet, a laptop, wall panel, or other device. The user interface 119 may connect to the cameras 110 via the network 102 or the local network 105. The user interface 119 may allow a user to access sensor data of the cameras 110. In an example, the user interface 119 may allow the user to view a field of view of the image sensors 115 and hear audio data from the microphones 118. In an example, the user interface may allow the user to view a representation, such as a point cloud, of radar data from the radar sensors 114.

The user interface 119 may allow a user to provide input to the cameras 110. In an example, the user interface 119 may allow a user to speak or otherwise provide sounds using the speakers 116.

In some implementations, the cameras 110 may receive additional data from one or more additional sensors, such as a door sensor 135 of the door 132, an electronic lock 133 of the door 132, a doorbell camera 134, and/or a window sensor 139 of the window 136. The door sensor 135, the electronic lock 133, the doorbell camera 134 and/or the window sensor 139 may be connected to the local network 105 and/or the network 102. The cameras 110 may receive the additional data from the door sensor 135, the electronic lock 133, the doorbell camera 134 and/or the window sensor 139 from the server 120.

In some implementations, the cameras 110 may determine separate and/or independent likelihoods that an object is within an area based on data from different sensors (e.g., processing data separately, using separate machine learning and/or other artificial intelligence, using separate metrics, or the like). The cameras 110 may combine data, likelihoods, determinations, or the like from multiple sensors such as image sensors 115, the radar sensors 114, and/or the microphones 118 into a single determination of whether an object is within an area (e.g., in order to perform an action relative to the object 170 within the area. For example, the cameras 110 and/or each of the cameras 110 may use a voting algorithm and determine that the object 170 is present within an area in response to a majority of sensors of the cameras and/or of each of the cameras determining that the object 170 is present within the area. In some implementations, the cameras 110 may determine that the object 170 is present within an area in response to all sensors determining that the object 170 is present within the area (e.g., a more conservative and/or less aggressive determination than a voting algorithm). In some implementations, the cameras 110 may determine that the object 170 is present within an area in response to at least one sensor determining that the object 170 is present within the area (e.g., a less conservative and/or more aggressive determination than a voting algorithm).

The cameras 110, in some implementations, may combine confidence metrics indicating likelihoods that the object 170 is within an area from multiple sensors of the cameras 110 and/or additional sensors (e.g., averaging confidence metrics, selecting a median confidence metric, or the like) in order to determine whether the combination indicates a presence of the object 170 within the area. In some embodiments, the cameras 110 are configured to correlate and/or analyze data from multiple sensors together. For example, the cameras 110 may detect a person or other object in a specific area and/or field of view of the image sensors 115 and may confirm a presence of the person or other object using data from additional sensors of the cameras 110 such as the radar sensors 114 and/or the microphones 118, confirming a sound made by the person or other object, a distance and/or speed of the person or other object, or the like. The cameras 110, in some implementations, may detect the object 170 with one sensor and identify and/or confirm an identity of the object 170 using a different sensor. In an example, the cameras detect the object 170 using the image sensor 115a of the first camera 110a and verifies the object 170 using the radar sensor 114b of the second camera 110b. In this manner, in some implementations, the cameras 110 may detect and/or identify the object 170 more accurately using multiple sensors than may be possible using data from a single sensor.

The cameras 110, in some implementations, in response to determining that a combination of data and/or determinations from the multiple sensors indicates a presence of the object 170 within an area, may perform initiate, or otherwise coordinate one or more actions relative to the object 170 within the area. For example, the cameras 110 may perform an action including emitting one or more sounds from the speakers 116, turning on a light, turning off a light, directing a lighting element toward the object 170, opening or closing the garage door 162, turning a sprinkler on or off, turning a television or other smart device or appliance on or off, activating a smart vacuum cleaner, activating a smart lawnmower, and/or performing another action based on a detected object, based on a determined identity of a detected object, or the like. In an example, the cameras 110 may actuate an interior light 137 of the building 130 and/or an exterior light 138 of the building 130. The interior light 137 and/or the exterior light 138 may be connected to the local network 105 and/or the network 102.

In some embodiments, the security system 101 and/or security device may perform initiate, or otherwise coordinate an action selected to deter a detected person (e.g., to deter the person from the area and/or property, to deter the person from damaging property and/or committing a crime, or the like), to deter an animal, or the like. For example, based on a setting and/or mode, in response to failing to identify an identity of a person (e.g., an unknown person, an identity failing to match a profile of an occupant or known user in a library, based on facial recognition, based on bio-identification, or the like), and/or in response to determining a person is engaged in suspicious behavior and/or has performed a suspicious action, or the like, the cameras 110 may perform, initiate, or otherwise coordinate an action to deter the detected person. In some implementations, the cameras 110 may determine that a combination of data and/or determinations from multiple sensors indicates that the detected human is, has, intends to, and/or may otherwise perform one or more suspicious acts, from a set of predefined suspicious acts or the like, such as crawling on the ground, creeping, running away, picking up a package, touching an automobile and/or other vehicle, opening a door of an automobile and/or other vehicle, looking into a window of an automobile and/or other vehicle, opening a mailbox, opening a door, opening a window, throwing an object, or the like.

In some implementations, the cameras 110 may monitor one or more objects based on a combination of data and/or determinations from the multiple sensors. For example, in some embodiments, the cameras 110 may detect and/or determine that a detected human has picked up the object 170 (e.g., a package, a bicycle, a mobile phone or other electronic device, or the like) and is walking or otherwise moving away from the home or other building 130. In a further embodiment, the cameras 110 may monitor a vehicle, such as an automobile, a boat, a bicycle, a motorcycle, an offroad and/or utility vehicle, a recreational vehicle, or the like. The cameras 110, in various embodiments, may determine if a vehicle has been left running, if a door has been left open, when a vehicle arrives and/or leaves, or the like.

The environment 100 may include one or more regions of interest, which each may be a given area within the environment. A region of interest may include the entire environment 100, an entire site within the environment, or an area within the environment. A region of interest may be within a single site or multiple sites. A region of interest may be inside of another region of interest. In an example, a property-scale region of interest which encompasses an entire property within the environment 100 may include multiple additional regions of interest within the property.

The environment 100 may include a first region of interest 140 and/or a second region of interest 150. The first region of interest 140 and the second region of interest 150 may be determined by the AI models 113, fields of view of the image sensors 115 of the cameras 110, fields of view of the radar sensors 114, and/or user input received via the user interface 119. In an example, the first region of interest 140 includes a garden or other landscaping of the building 130 and the second region of interest 150 includes a driveway of the building 130. In some implementations, the first region of interest 140 may be determined by user input received via the user interface 119 indicating that the garden should be a region of interest and the AI models 113 determining where in the fields of view of the sensors of the cameras 110 the garden is located. In some implementations, the first region of interest 140 may be determined by user input selecting, within the fields of view of the sensors of the cameras 110 on the user interface 119, where the garden is located. Similarly, the second region of interest 150 may be determined by user input indicating, on the user interface 119, that the driveway should be a region of interest and the AI models 113 determining where in the fields of view of the sensors of the cameras 110 the driveway is located. In some implementations, the second region of interest 150 may be determined by user input selecting, on the user interface 119, within the fields of view of the sensors of the cameras 110, where the driveway is located.

In response to determining that a combination of data and/or determinations from the multiple sensors indicates that a detected human (e.g., an entity) is, has, intends to, and/or may otherwise perform one or more suspicious acts, is unknown/unrecognized, has entered a restricted area/zone such as the first region of interest 140 or the second region of interest 150, the security system 101 and/or security devices may expedite a deter action, reduce a waiting/monitoring period after detecting the human and before performing a deter action, or the like. In response to determining that a combination of data and/or determinations from the multiple sensors indicates that a detected human is continuing and/or persisting performance of one or more suspicious acts, the cameras 110 may escalate one or more deter actions, perform one or more additional deter actions (e.g., a more serious deter action), or the like. For example, the cameras 110 may play an escalated and/or more serious sound such as a siren, yelling, or the like; may turn on a spotlight, strobe light, or the like; and/or may perform, initiate, or otherwise coordinate another escalated and/or more serious action. In some embodiments, the cameras 110 may enter a different state (e.g., an armed mode, a security mode, an away mode, or the like) in response to detecting a human in a predefined restricted area/zone or other region of interest, or the like (e.g., passing through a gate and/or door, entering an area/zone previously identified by an authorized user as restricted, entering an area/zone not frequently entered such as a flowerbed, shed or other storage area, or the like).

In a further embodiment, the cameras 110 may perform, initiate, or otherwise coordinate, a welcoming action and/or another predefined action in response to recognizing a known human (e.g., an identity matching a profile of an occupant or known user in a library, based on facial recognition, based on bio-identification, or the like) such as executing a configurable scene for a user, activating lighting, playing music, opening or closing a window covering, turning a fan on or off, locking or unlocking a door 132, lighting a fireplace, powering an electrical outlet, turning on or play a predefined channel or video or music on a television or other device, starting or stopping a kitchen appliance, starting or stopping a sprinkler system, opening or closing a garage door 162, adjusting a temperature or other function of a thermostat or furnace or air conditioning unit, or the like. In response to detecting a presence of a known human, one or more safe behaviors and/or conditions, or the like, in some embodiments, the cameras 110 may extend, increase, pause, toll, and/or otherwise adjust a waiting/monitoring period after detecting a human, before performing a deter action, or the like.

In some implementations, the cameras 110 may receive a notification from a user’s smart phone that the user is within a predefined proximity or distance from the home, e.g., on their way home from work. Accordingly, the cameras 110 may activate a predefined or learned comfort setting for the home, including setting a thermostat at a certain temperature, turning on certain lights inside the home, turning on certain lights on the exterior of the home, turning on the television, turning a water heater on, and/or the like.

The cameras 110, in some implementations, may be configured to detect one or more health events based on data from one or more sensors. For example, the cameras 110 may use data from the radar sensors 114 to determine a heartrate, a breathing pattern, or the like and/or to detect a sudden loss of a heartbeat, breathing, or other change in a life sign. The cameras 110 may detect that a human has fallen and/or that another accident has occurred.

In some embodiments, the security system 101 and/or one or more security devices may include one or more speakers 116. The speaker(s) 116 may be independent from other devices or integrated therein. For example, the camera(s) may include one or more speakers 116 (e.g., speakers 116a, 116b) that enable sound to be output therefrom. In an embodiment, a controller or other device may include a speaker from which sound (e.g., alarm sound, tones, verbal audio, and/or otherwise) may be output. The controller may be configured to cause audio sounds (e.g., verbal commands, dog barks, alarm sounds, etc.) to play and/or otherwise emit the audio from the speaker(s) 116 located at the building 130. In an embodiment, one or more sounds may be output in response to detecting the presence of a human within an area. For example, the controller may cause the speaker may play one or more sounds selected to deter a detected person from an area around a building 130, environment 100, and/or object. The speaker(s) 116, in some implementations, may vary sounds over time, dynamically layer and/or overlap sounds, and/or generate unique sounds, to preserve a deterrent effect of the sounds over time and/or to avoid, limit, or even prevent those being deterred from becoming accustomed to the same sounds used over and over.

The security system 101, one or more security devices, and/or the speakers 116, in some implementations, may be configured to store and/or has access to a library comprising a plurality of different sounds and/or a set of dynamically generated sounds so that the controller (e.g., user interface 119) may vary the different sounds over time, thereby not using the same sound too often. In some embodiments, varying and/or layering sounds allows a deter sound to be more realistic and/or less predictable.

One or more of the sounds may be selected to give a perception of human presence in the environment 100 or building 130, a perception of a human talking over an electronic speaker 116 in real-time, or the like which may be effective at preventing crime and/or property damage. For example, a library and/or other set of sounds may include audio recordings and/or dynamically generated sounds of one or more, male and/or female voices saying different phrases, such as for example, a female saying "hello?," a female and male together saying "can we help you?," a male with a gruff voice saying, "get off my property" and then a female saying "what's going on?," a female with a country accent saying "hello there,” a dog barking, a teenager saying "don't you know you’re on camera?," and/or a man shouting "hey!" or "hey you!," or the like.

In some implementations, the security system 101, one or more security devices, and/or the speaker 116 may dynamically generate one or more sounds (e.g., using machine learning and/or other artificial intelligence, or the like) with one or more attributes that vary from a previously played sound. For example, the security system, one or more security devices, and/or the speaker 116 may generate sounds with different verbal tones, verbal emotions, verbal emphases, verbal pitches, verbal cadences, verbal accents, or the like so that the sounds are said in different ways, even if they include some or all of the same words. In some embodiments, the security system 101, one or more security devices, the speaker 116 and/or a remote computer (e.g. server 120) may train machine learning on reactions of previously detected humans in other areas to different sounds and/or sound combinations (e.g., improving sound selection and/or generation over time).

The security system 101, one or more security devices, and/or the speaker 116 may combine and/or layer these sounds (e.g., primary sounds), with one or more secondary, tertiary, and/or other background sounds, which may comprise background noises selected to give an appearance that a primary sound is a person speaking in real time, or the like. For example, a secondary, tertiary, and/or other background sound may include sounds of a kitchen, of tools being used, of someone working in a garage, of children playing, of a television being on, of music playing, of a dog barking, or the like. The security system 101, one or more security devices, and/or the speaker 116, in some embodiments, may be configured to combine and/or layer one or more tertiary sounds with primary and/or secondary sounds for more variety, or the like. For example, a first sound (e.g., a primary sound) may comprise a verbal language message and a second sound (e.g., a secondary and/or tertiary sound) may comprise a background noise for the verbal language message (e.g., selected to provide a real-time temporal impression for the verbal language message of the first sound, or the like).

In this manner, in various embodiments, the security system 101, one or more security devices, and/or the speaker 116 may intelligently track which sounds and/or combinations of sounds have been played, and in response to detecting the presence of a human, may select a first sound to play that is different than a previously played sound, may select a second sound to play that is different than the first sound, and may play the first and second sounds at least partially simultaneously and/or overlapping. For example, the security system 101, one or more security devices, and/or the speaker 116 may play a primary sound layered and/or overlapping with one or more secondary, tertiary, and/or background sounds, varying the sounds and/or the combination from one or more previously played sounds and/or combinations, or the like.

The security system 101, one or more security devices, and/or the speaker 116, in some embodiments, may select and/or customize an action based at least partially on one or more characteristics of a detected object. For example, the cameras 110 may determine one or more characteristics of the object 170 based on audio data, image data, depth data, and/or other data from a sensor. For example, the cameras 110 may determine a characteristic such as a type or color of an article of clothing being worn by a person, a physical characteristic of a person, an item being held by a person, or the like. The cameras 110 may customize an action based on a determined characteristic, such as by including a description of the characteristic in an emitted sound (e.g., “hey you in the blue coat!”, “you with the umbrella!”, or another description), or the like.

The security system 101, one or more security devices, and/or the speaker 116, in some implementations, may escalate and/or otherwise adjust an action over time and/or may perform a subsequent action in response to determining (e.g., based on data and/or determinations from one or more sensors, from the multiple sensors, or the like) that the object 170 (e.g., a human, an animal, vehicle, drone, etc.) remains in an area after performing a first action (e.g., after expiration of a timer, or the like). For example, the security system 101, one or more security devices, and/or the speaker 116 may increase a volume of a sound, emit a louder and/or more aggressive sound (e.g., a siren, a warning message, an angry or yelling voice, or the like), increase a brightness of a light, introduce a strobe pattern to a light, and/or otherwise escalate an action and/or subsequent action. In some implementations, the security system 101, one or more security devices, and/or the speaker 116 may perform a subsequent action (e.g., an escalated and/or adjusted action) relative to the object 170 in response to determining that movement of the object 170 satisfies a movement threshold based on subsequent depth data from the radar sensors 114 (e.g., subsequent depth data indicating the object 170 is moving and/or has moved at least a movement threshold amount closer to the radar sensors 114, closer to the building 130, closer to another identified and/or predefined object, or the like).

In some implementations, the cameras 110 and/or the server 120 (or other device), may include image processing capabilities and/or radar data processing capabilities for analyzing images, videos, and/or radar data that are captured with the cameras 110. The image/radar processing capabilities may include object detection, facial recognition, gait detection, and/or the like. For example, the controller 106 may analyze or process images and/or radar data to determine that a package is being delivered at the front door/porch. In other examples, the cameras 110 may analyze or process images and/or radar data to detect a child walking within a proximity of a pool, to detect a person within a proximity of a vehicle, to detect a mail delivery person, to detect animals, and/or the like. In some implementations, the cameras 110 may utilize the AI models 113 for processing and analyzing image and/or radar data.

In some implementations, the security system 101, one or more security devices, and/or the speaker 116 are connected to various IoT devices. As used herein, an IoT device may be a device that includes computing hardware to connect to a data network and to communicate with other devices to exchange information. In such an embodiment, the cameras 110 may be configured to connect to, control (e.g., send instructions or commands), and/or share information with different IoT devices. Examples of IoT devices may include home appliances (e.g. stoves, dishwashers, washing machines, dryers, refrigerators, microwaves, ovens, coffee makers), vacuums, garage door openers, thermostats, HVAC systems, irrigation/sprinkler controller, television, set-top boxes, grills/barbeques, humidifiers, air purifiers, sound systems, phone systems, smart cars, cameras, projectors, and/or the like. In some implementations, the cameras 110 may poll, request, receive, or the like information from the IoT devices (e.g., status information, health information, power information, and/or the like) and present the information on a display and/or via a mobile application.

The IoT devices may include a smart home device 131. The smart home device 131 may be connected to the IoT devices. The smart home device 131 may receive information from the IoT devices, configure the IoT devices, and/or control the IoT devices. In some implementations, the smart home device 131 provides the cameras 110 with a connection to the IoT devices. In some implementations, the cameras 110 provide the smart home device 131 with a connection to the IoT devices. The smart home device 131 may be an AMAZON ALEXA™ device, an AMAZON ECHO™, A GOOGLE NEST™ device, a GOOGLE HOME™ device, or other smart home hub or device. In some implementations, the smart home device 131 may receive commands, queries, or other signals, such as voice commands, and relay the commands to the cameras 110. In some implementations, the cameras 110 may cause the smart home device 131 to emit sound and/or light, speak words, or otherwise notify a user of one or more conditions via the user interface 119.

In some implementations, the IoT devices include various lighting components including the interior light 137, the exterior light 138, the smart home device 131, other smart light fixtures or bulbs, smart switches, and/or smart outlets. For example, the cameras 110 may be communicatively connected to the interior light 137 and/or the exterior light 138 to turn them on/off, change their settings (e.g., set timers, adjust brightness/dimmer settings, and/or adjust color settings).

In some implementations, the IoT devices include one or more speakers within the building. The speakers may be stand-alone devices such as speakers that are part of a sound system, e.g., a home theatre system, a doorbell chime, a Bluetooth speaker, and/or the like. In some implementations, the one or more speakers may be integrated with other devices such as televisions, lighting components, camera devices (e.g., security cameras that are configured to generate an audible noise or alert), and/or the like. In some implementations, the speakers may be integrated in the smart home device 131.

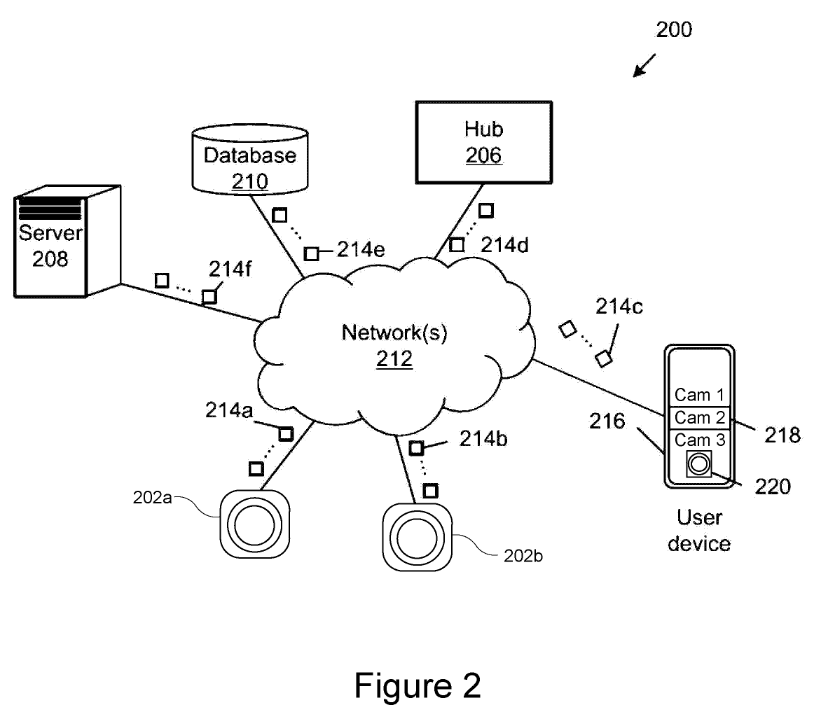

Turning now to FIG. 2, a system 200, for securing a location or enclosed space (e.g., a building or other premise) is shown, according to an embodiment. The system 200 may correspond to a building, an open space, an enclosed space, or the like. The enclosed space may be, for example, any edifice, structure, or enclosure including one or more walls and one or more entrances. In the present disclosure, the building may include, but is not limited to, a home, office, store, business, courtyard, etc. The system 200 corresponding to the building may include one or more of the first camera 202a and the second camera 202b. One or both of the first camera 202a and the second camera 202b may be located internal and/or external relative to the space. The system 200 may further include a server 208, a database 210, one or more networks 212 (e.g., a local network may be part of the system 200 provided by the security system), and/or a user device 216. The various devices and components of the system 200 may communicate with one another via the one or more networks 212. The user device 216 may be used to access, view, control, and/or adjust one or more components of the system 200. By way of example, and for ease of description, as one or more of the first camera 202a and the second camera 202b may be positioned exterior to the building. For example, the first camera 202a may include the first camera 110a of FIG. 1 and the second camera 202b may include the second camera 110b of FIG. 1. One of more of the first camera 202a and the second camera 202b may include the doorbell camera 134 of FIG. 1.

Herein, one or more of the first camera 202a and the second camera 202b may be referenced as “camera(s) 202.” In some embodiments, camera 202 may be positioned to capture images corresponding to a Region of Interest (ROI) such as a primary door, which may be a front door, a gate, a garage door, or any other entrance of the enclosed space or region of a corresponding portion of the property.

According to some embodiments, the camera 202 may correspond to a driveway, door, front yard, porch, side yard, back yard, or the like which a user of the system 200 may wish to monitor. Though the term “door” is used in various terms of the present disclosure, it should be understood that the any mechanism or means for entering/exiting the building may be encompassed in the term “door.” For example, “door” may encompass sliding doors, rotating doors, windows, gates, overhead doors, barn doors, etc.

For ease of description and understanding, FIG. 2 depicts the system 200 as having one or a small number of each component. Embodiments may, however, include additional or alternative components, or omit certain components, from those of FIG. 2 and still fall within the scope of this disclosure. As an example, it may be common for embodiments to include multiple servers 208 and/or multiple databases 210 that are communicably coupled to or operated by the server 208 and the primary exterior lock interface 202a through the network 212. Embodiments may include or otherwise implement any number of devices capable of performing the various features and tasks described herein. For instance, FIG. 2 depicts the database 210 as hosted as or operated as a distinct computing device from the server 208, though, in some embodiments, the server 208 may include an integrated database 210 hosted by the server 208.

The system 200 may include or utilize one or more networks 212, which may include any number of internal networks (e.g., LANs), external networks (e.g., WANs), private networks (e.g., intranets, VPNs), and public networks (e.g., Internet). The network(s) 212 may include various hardware and software components for hosting and conducting communications amongst the components of the system 200. Moreover, non-limiting examples of such internal or external networks 212 may include a Local Area Network (LAN), Wireless Local Area Network (WLAN), Metropolitan Area Network (MAN), Wide Area Network (WAN), and the Internet. The communication over the networks 212 may be performed in accordance with various communication protocols, such as Transmission Control Protocol and Internet Protocol (TCP/IP), User Datagram Protocol (UDP), and IEEE communication protocols, among others. Additional, and/or alternative communication protocols that may be used by the network(s) 212 may include Wi-Fi, Bluetooth, Zigbee, Z-Wave, Thread, Insteon, LoRaWAN, KNK, DALI, and/or UPnP.

The server 208 may include one or more processors that execute one or more software programs to perform various processes. The server 208 may include processor(s) and non-transitory, computer readable medium including instructions, which, when executed by the processor(s), cause the processor to perform methods disclosed herein. The processor(s) may include any number of physical, hardware processor. Although FIG. 2 shows only a single server 208, the server 208 may include any number of computing devices. In some cases, the computing devices of the server 208 may perform all or portions of the processes described herein to support the system 200. The server 208 may include computing devices (e.g., processors) operating in a distributed or cloud computing configuration and/or in a virtual machine configuration. It should also be appreciated that, in some embodiments, one or more functions of the server 208 may be partly or entirely performed by the primary exterior lock interface 202a or any other component (e.g., the hub 206).

The hub 206 may be communicatively coupled with the various components of the system 200 and/or other smart devices of the building directly or indirectly (e.g., through the network(s) 212, as shown in FIG. 2). By way of example, the hub 206 may receive control signals from, and transmit the control signals to, the cameras 110. The hub 206 may be configured to receive various communication protocol signals and translate the various communication protocol signals into control signals to control the various components of the system 200.

The camera 202 may be any type of electronic device including hardware components (e.g., one or more processors, non-transitory memory, user interface, housing, etc.) and software components capable of imaging, detecting, or otherwise generating signals corresponding to the environment 100. For example, the camera 202 may include one or more communication components for receiving instructions and interactions from the user. The cameras 202 may include similar or distinct exterior elements relative to the hub 206. Non-limiting examples of the components that may be included in the system 200 include smart home devices (e.g., smart locks, smart switches, etc.), personal computers (e.g., laptop computers, desktop computers), server computers, mobile devices (e.g., smartphones, tablets), VR devices, and gaming consoles, smart watches, among other types of electronic devices. In an illustrative embodiment, the first camera 202a is configured to operate in conjunction with the second camera 202b so as to function as a single monitoring component for the system 200. As will be described in greater detail below, the cameras 202 may provide images or other data for processing and organization by the system 200.

The user device 216 (e.g., a mobile electronic device, such as a smartphone) may be any type of electronic device comprising hardware components (e.g., one or more processors, non-transitory storage medium, user interface) and software components capable of performing the various processes and tasks described herein. Non-limiting examples of the user device 216 include personal computers (e.g., laptop computers, desktop computers), server computers, mobile devices (e.g., smartphones, tablets), VR devices, and gaming consoles, smart watches, among other types of electronic devices. In an illustrative embodiment, the user device 216 is a mobile electronic device executing one or more mobile applications that are configured to communicate with (e.g., transmit to and receive from) the various components of the system 200. The user device 216 may include an electronic display, a user interface, communication electronics, and a physical housing.

The user device 216 may include one or more computing devices configured to execute one or more software programs (e.g., mobile applications or apps) to perform various processes. In some embodiments, the user device 216 may be a computer or computing device capable of performing the same or similar methods disclosed herein as performed by the user device 216. The user device 216 may include a processor and non-transitory, computer-readable medium including instructions, which, when executed by the processor, causes the processor to perform methods disclosed herein. Although FIG. 2 shows only a single user device 216, the user device 216 may include any number of devices associated with one or more users. In some cases, the computing devices of the user device 216 may perform at least a portion of the processing processes of the cameras 202 and/or the hub 206. Moreover, the user device 216 may support processes and/or interact with any of the components of the system 200.

By way of example, the user of the system 200 may interact with the user device 216 to select one or more selectable elements 218 or buttons (each element 218 may be associated with a corresponding smart lock/door) to select one or more of the cameras 202, adjust a state of one or more of the cameras 202, review imagery or other data captured by one or more of the cameras 202, or otherwise interact with the cameras 202 or data captured by the cameras 202. The user may interact with one or more of the selectable element 218 to identify a specific one of the cameras 202, a subset of available cameras 202, or all cameras 202 connected with the system 200. The selectable elements 218 of the user device 216 may represent one or more of the cameras 202, a feed of the cameras 202, a setting of one or more of the cameras 202, or the like. In response to receiving an input at the selected elements 218, 220, the user device 216 may transmit a control signal (either directly or indirectly) to the corresponding one or more cameras 202 based on the selected element 218 to execute a corresponding function, operation, or the like as indicated by the selected elements 218, 220. The control signal may bring up data from one or more selected cameras 202 or perform another action corresponding to the one or more cameras 202.

In some embodiments, rather than having to interact with multiple elements 218, 220, the elements 218 may control one or more of the selection and state of the camera(s) 202 by, for example, holding the element 218 for a certain period of time, tap an element multiple times within a maximum time period (e.g., 2 taps within 0.5 seconds), swipe across one or more elements 218, or perform another gesture or input. Other user interface elements and processes for interacting with these elements may be provided and utilized in interacting with one or more of the cameras 202.

Control and informational signals may be transmitted between the components of the system 200. For example, the signals 214a, 214b, 214c, 214d, 214e, and/or 214f (collectively 214), may be transmitted between and amongst components through the network(s) 212. As described herein, the signals 214 may be transmitted utilizing any suitable communication protocol. According to illustrative embodiments, the signals 214a-214f may be transmitted directly between components of the system 200. Alternatively, or additionally, the signals 214 may be transmitted from one or more of the cameras 202 in response to detection of an object, person, movement, etc. to a single component (e.g., the hub 206 and/or one or more of the cameras 202) and then relayed from the single component to one or more other components of the system 200.

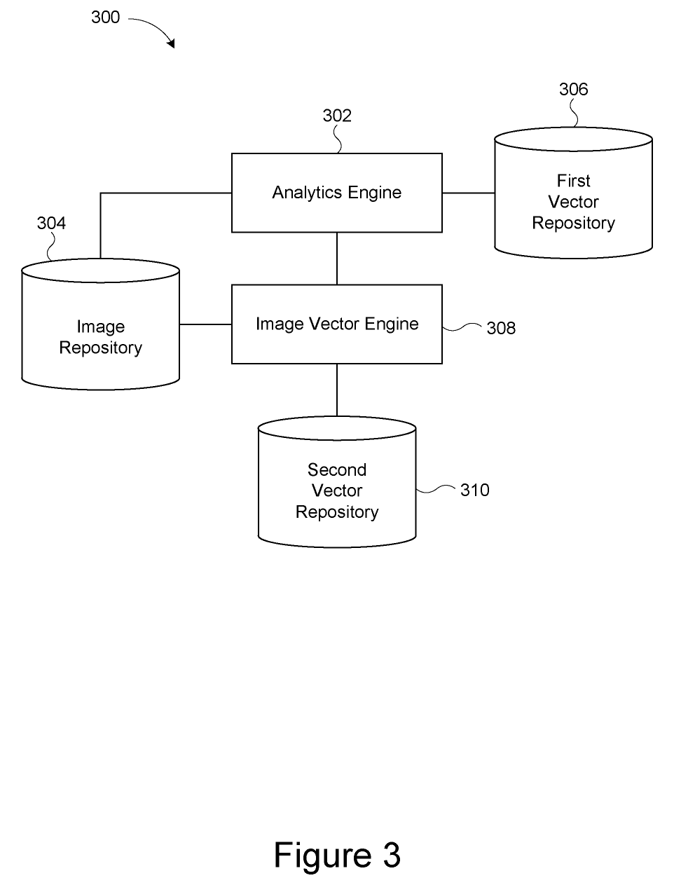

FIG. 3 is a block diagram 300 for vector processing in a system, for example, an alarm system. In some embodiments, the block diagram 300 includes an analytics engine 302. The analytics engine 302 may include logic. For example, the analytics engine 302 may include image detection logic. The analytics engine 302 may be configured to implement image detection logic to identify an object from image data captured by a camera. For example, the analytics engine 302 may identify frame of image data corresponding to an object detection. The analytics engine 302 may be configured to generate detection metadata for the frames associated with the object detection.

In some embodiments, the analytics engine 302 may implement a sampling logic. The sampling logic may prioritize a diversity of sampling. For example, the sampling logic may sample objects within the ROI and may, also or alternatively, sample objects outside the ROI to allow for greater search capability and diversity of results. This may result in a higher surface area of indexing. In some embodiments, the sampling logic may be supplemented with a prioritization logic to identify areas where additional sampling is needed to enrich a database (e.g., first vector repository 306, second vector repository 310, etc.). In some embodiments, the prioritization logic may identify objects that have a sampling rate over a threshold. For example, objects that are sampled over the threshold may be deprioritized to avoid oversaturation of a database and to improve resource allocation and expense by avoiding less-beneficial sampling, indexing, vector analysis, etc.

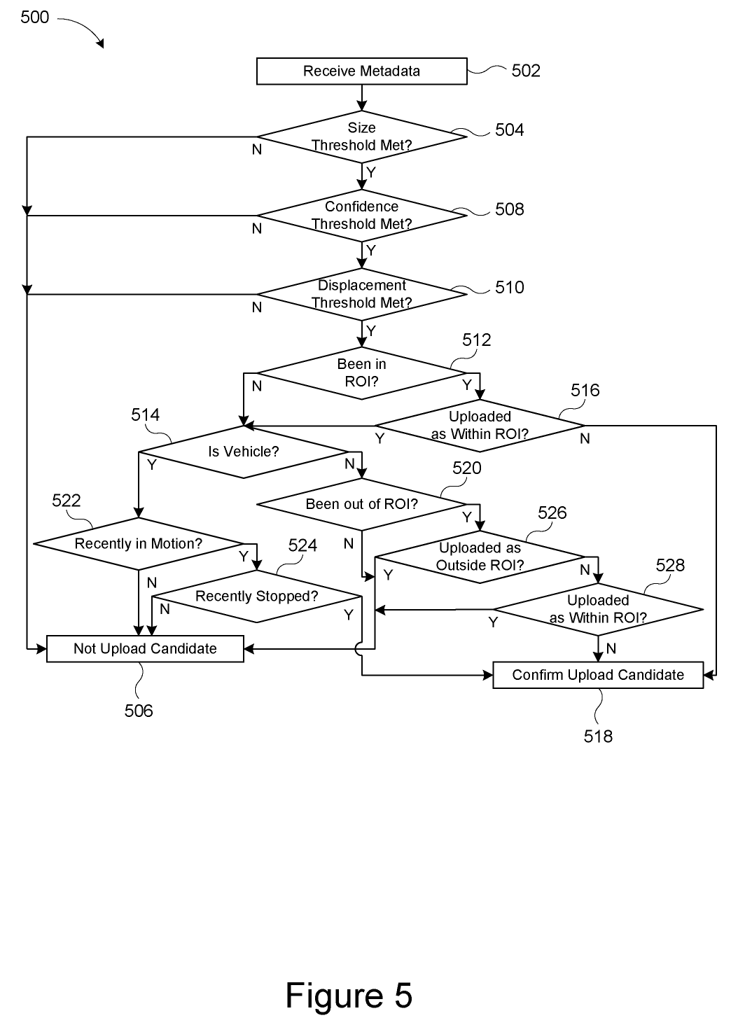

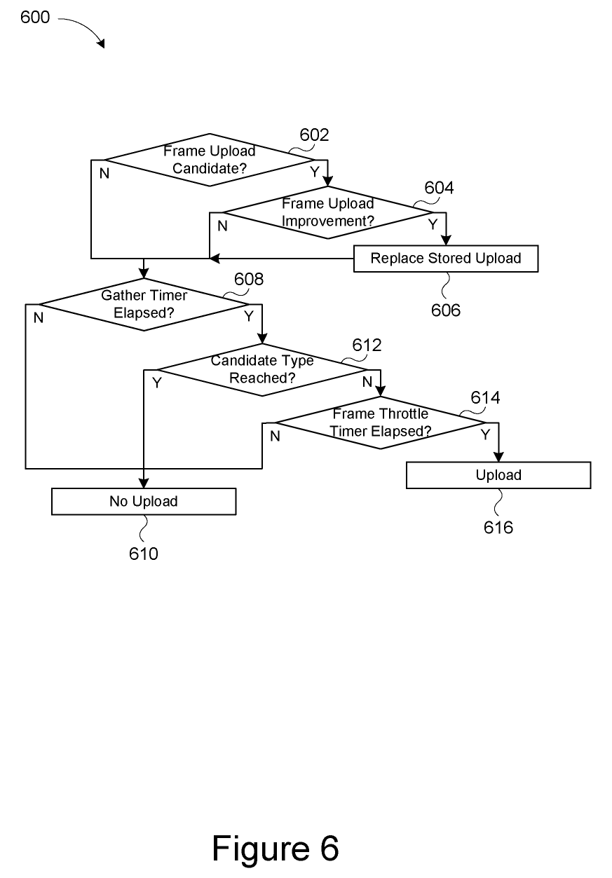

In some embodiments, one or more of the sampling logic the prioritization logic may identify one or more criteria that qualify the object for sampling. For example, an object determined to be moving may be given a higher priority. An object that has not been sampled before may be prioritized. An object that has not been sampled in a particular timeframe (e.g., detected schedule, routine, etc.) may be prioritized. An object that has not been sampled in a particular condition or set of conditions (e.g., lighting, weather, position, ROI correspondence, proximity, etc.) may be prioritized. In some embodiments, one or more of the sampling logic and/or the prioritization logic may process images based on the source of the image. For example, images from a doorbell camera may be prioritized while images from an indoor camera may be deprioritized. In some embodiments, more than one criteria may be used to identify object for sampling and prioritize the sampling of those images. For example if images from a new doorbell camera added to the system are needed to diversify a database and low-light images are needed, sampling of objects detected by the doorbell camera during low-light conditions may be prioritized over low-light detected objects from another outdoor camera. Other hierarchies and prioritization thresholds and metrics may be implemented. Further examples of selection and prioritization can be found with reference to FIGS. 5 and 6 and the corresponding description presented herein.

In some embodiments, the analytics engine 302 sends image data and the detection metadata associated with an object detection to an image repository 304. The image repository 304 may be a local, remote, and/or distributed storage resource. In one example, the image repository 304 is a Google™ storage resource. In some embodiments, the analytics engine 302 sends the detection metadata to the first vector repository 306. The first vector repository 306 may be a memory component of a camera of an alarm system or may be a memory or other storage component located remote relative to the camera.

In response to the image data and detection metadata being stored at the image repository 304, an image vector engine 308 may execute a function to create a vector embedding associated with the image data and the detection metadata. The vector embedding may be a numerical or other code associated with the object detection. In some embodiments, the image vector engine 308 may send the vector embedding to a second vector repository 310.

The vector embedding may be stored in the second vector repository 310 for retrieval by the analytics engine 302. For example, the analytics engine 302 may periodically check for new vector embeddings in the second vector repository 310 and retrieve the new vector embeddings in response to detection. In other embodiments, the analytics engine 302 may retrieve new vector embeddings in response to an event trigger sent by the image vector engine 308 or another component of the alarm system or other trigger source in communication with the alarm system.

In some embodiments, the analytics engine 302 may store one or more new vector embeddings, retrieved from the second vector repository 310, to the first vector repository 306. One or more vector embeddings stored in the first vector repository 306 may be reference by the analytics engine 302, or another component, in a search or other function benefitted by the vector embeddings.

In some embodiments, the first vector repository 306 may be local to a specific component of a system. For example, the first vector repository 306 may be an on-board storage resource of a first camera (e.g., doorbell camera 134 of FIG. 1). In some embodiments, the first camera may communicate one or more vectors, stored on the first camera, with a second camera. In this manner, the vectors may identify similar events and allow for disparate components to identify similar or related events through the use of vectors.

In some embodiments, an event which is recorded by both the first and the second components of a system (e.g., doorbell camera and outdoor camera), may be stitched together to provide a single data playback from both devices by utilizing shared vectors. As the vectors may be shared between components, identification of an object or event to allow for stitching together of the data from both components to form continuity between the components and more completely/accurately communicate the event to a user.

In some embodiments, all or some of the vector processing shown in the block diagram 300 may reside and/or occur on a device (e.g., a camera, hub, or the like) local to an alarm system (e.g., premises at which an alarm system is installed) or may reside and/or occur on a device (server, cloud, or the like) remote to the alarm system.

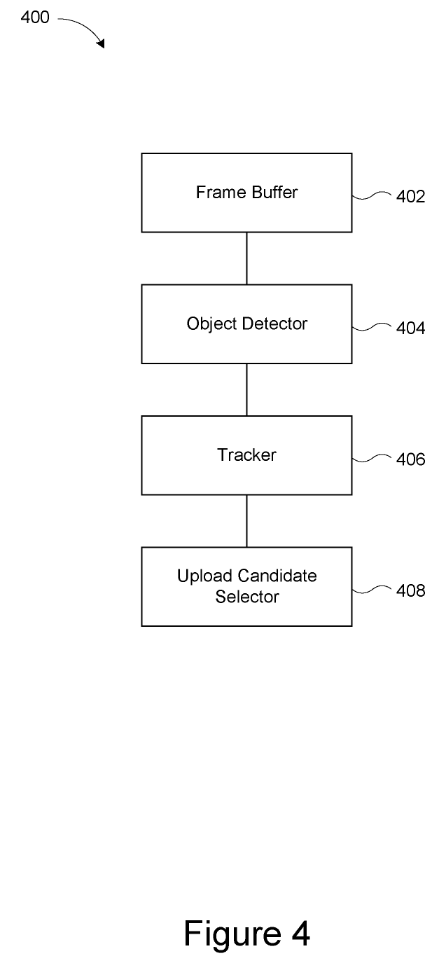

FIG. 4 is a block diagram 400 for sampling in a system, such as an alarm system. In the illustrated embodiment, the block diagram 400 includes a frame buffer 402. The frame buffer 402 may be a local or remote storage location to store data corresponding to one or more devices of an alarm system (e.g., a doorbell camera, microphone, radar, lidar, etc.). The data may be time sequenced (e.g., timestamped or otherwise arranged/stored based on time). In some embodiments, the frame buffer 402 may be local to the device recording the data. For example, the frame buffer 402 may be onboard a camera (e.g., doorbell camera or other camera). In other embodiments, the frame buffer 402 may be located on another device of the system such as a hub or other storage-enabled device. In other embodiments, the frame buffer 402 may be located remote to the alarm system (e.g., cloud, distributed storage, network storage, etc.).

In the illustrated embodiment, the frame buffer 402 communicated data to an object detector 404. For example, the frame buffer 402 may provide the data in one or more forms. For example, the frame buffer 402 may provide one or more YUV frames. A YUV frame may provide a luminance value (Y) and chrominance values (U and V). This may provide functionality for subsampling and other processes. Other formats and organizations may also be used, particularly for different types of data from different sources (e.g., video, audio, radar, lidar, etc.).

The object detector 404 may be configured to receive the data from the frame buffer 402 and perform one or more analyses on the data to identify objects and/or data corresponding to an object from the data. Based on an identification of an object in the data, the object detector 404 may be generate metadata corresponding to the data. The object detector 404 may be configured to associate metadata with each frame or other unit or measure of the data. In some embodiments, the metadata may be associated with a group of frames or other collection of data.

The object detector 404 may be configured to provide detections metadata to a tracker 406. The object detector 404 may provide the metadata to the tracker with the associated data or may provide the associated data with the metadata sent to the tracker 406. The tracker 406 may analyze the detections metadata to generate one or more tracking IDs associated with the data. For example, a tracking ID may be generated which may be used to identify one or more objects from the data. For example, a tracking ID may be generated for a dog detected by the object detector 404 and identified from the metadata provided to the tracker 406.

In some embodiments, the tracker 406 provides one or more tracking IDs to an upload candidate selector 408. In some embodiments, the upload candidate selector 408 may receive the one or more tracking IDs and identify data corresponding to the one or more tracking IDs. The upload candidate selector 408 may upload the selected data for searching and/or viewing by a user. For example, the upload candidate selector 408 may select the data for upload. Examples of at least some logic implemented by the upload candidate selector 408 may be shown in FIGS. 5 and 6 and the associated description below.

FIG. 5 is a logic diagram 500 for upload candidate selection. The illustrated embodiment depicts one example have a process that may be executed by the upload candidate selector 408 of FIG. 4. In the illustrated example, at block 502, metadata is received. In some embodiments, the received metadata may be the metadata generated by the object detector 404 of FIG. 4. The metadata may be received by the upload candidate selector 408 of FIG. 4. Based on the received metadata, an analysis may be performed by, for example, the upload candidate selector 408. In the illustrated embodiment, the metadata may be analyzed to determine if, at block 504, a size threshold is met. If the size threshold is not met, the meta data may be disqualified as an upload candidate at block 506. If the size threshold is met, at block 504, a confidence threshold check, at block 508, may be performed. If, at block 508, the confidence threshold is not met, the metadata may be disqualified, at block 506, as an upload candidate. If, at block 508, the confidence threshold is met the process may proceed to a displacement threshold check at block 510. If, at block 510, the displacement threshold has not been met, the meta data will be disqualified, at block 506, as an upload candidate. If, at block 510, the displacement threshold is met, a position check, relative to a region of interest (ROI), at block 512, may be performed.

If the object has not been within the ROI, an object classification check, at block 514, may be performed. While the illustrated embodiment references a vehicle check, other types or classifications of objects may be checked. For sake of conciseness, the vehicle example is used herein without restricting the disclosure to vehicles only.

If, based on analysis of the metadata, the object is determined, at block 512, to have been within the ROI, a check against previous uploads as being within the ROI, at block 516, may be performed. If, at block 516, data associated with the object has not been previously uploaded as being associated with an object within the ROI, data associated with the object may be confirmed as an upload candidate at block 518.

Returning to block 512, if the object has not been in the ROI, and, at block 514, the object is identified as a vehicle or other targeted class of object, a location check on the object as being identified outside of the ROI may be performed at block 520. If, at block 514, the object is positively identified as a vehicle or other targeted class of object, a motion check, at block 522, may be performed. In some embodiments, the motion check, at block 522, may have a timing component. For example, the timing component may be a default setting, a dynamic setting, a user-specified setting, or the like. If, at block 522, the motion has been detected within a time period, a stop check may be performed at block 524. If, at block 522, the object was not determined to have been recently in motion, the object may be disqualified, at block 506, as an upload candidate. If, at block 522, the object was determined to have recently been in motion and, at block 524, the object was determined to have not recently stopped, the object may be disqualified, at block 506, as an upload candidate.

Returning to block 520, if the object is determined to have been outside of the ROI, the check may be performed, at block 526, to determine if the object has been uploaded as outside the ROI. If, at block 526, the object has previously been uploaded as an object outside the ROI, the object may be disqualified, at block 506, as an upload candidate. If, at block 526, the object has not been previously uploaded as outside the ROI, a second check may be performed, at block 528, to determine if the object has previously been uploaded as within the ROI. If, at block five to eight, the object is determined to have been uploaded as within the ROI, the object may be disqualified, at block 506, as an upload candidate. If, at block 528, the object has been determined to not have been previously uploaded as within the ROI, the object may be confirmed, at block 518, as an upload candidate.

While various checks and analyses are described herein and shown in FIG. 5, in some embodiments, fewer or more confidence checks may be incorporated to reduce error and/or improve efficiency.

FIG. 6 is a logic diagram 600 for selected candidate upload. In some embodiments, once an upload candidate is confirmed for upload, additional check may be performed to optimize a dataset of uploaded images or other data types associated with the environment. In the illustrated diagram 600, a check is performed, at block 602, to determine if the data uploaded is a confirmed upload candidate. If, at block 602, the data is identified as a confirmed upload candidate, an improvement at check, at block 604, may be performed. For example, the upload candidate may be analyzed to determine if the upload candidate is of a higher image quality (e.g., bigger data, clearer data, etc.). If, at block 604, the upload candidate is determined to be an improvement, at block 606, the upload candidate is uploaded to replace a previous upload should one be present.

If, at block 602, the data is determined to be associated with an upload candidate that has been disqualified, or, at block 604, the upload candidate is determined not to be an improvement over a previous upload, a timer check, at block 608, may be performed to determine if a best time gather timer has elapsed. If, at block 608, the timer has not elapsed, the upload candidate may be denied, at block 610, for upload. If, at block 608, the gather timer has elapsed, a candidate detection threshold check, at block 612, may be performed. If, at block 612, a threshold corresponding to a candidate type has been reached, the upload candidate may be denied. If common at block 612, a threshold corresponding to the candidate type has not been reached, a throttle timer check, at block 614, may be performed. If, at block 614, the frame throttle timer has not elapsed, the upload candidate may be denied for upload. If, at block 614, the frame throttle timer has elapsed, the upload candidate may be confirmed, uploaded, and marked as uploaded.

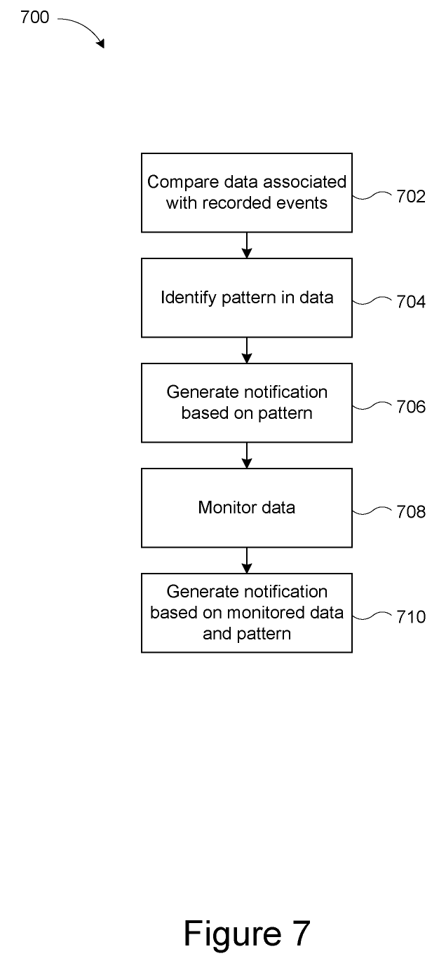

FIG. 7 is a flow diagram 700 for pattern identification and notification. In the illustrated embodiment, metadata, vectors, or other information corresponding to an event may be analyzed at block 702. At block 704, pattern recognition may be applied to identify a pattern in occurrence of the events. The pattern may correspond to timing of the event, objects associated with the event, or the like. For example, a garbage truck may be detected as present in the monitored environment every Wednesday morning. This may be identified based on the metadata associated with the day and/or time of day as well as an ID or vector associated with the garbage truck. In some embodiments, patterns may be detected based on a frequency with which a user interacts with a certain type of event, events occurring on a particular day and/or at a particular time, events involving a particular object, person, etc., or the like.

In some embodiments, the pattern detection may be associated with detected events. In other embodiments, the pattern detection may include non-detection events. Non-detection events may be used to establish or reinforce a pattern or may constitute and anomaly in the pattern. In other embodiments, the pattern detection may relate to a user input or response associated with the event. For example, a pattern of setting the system to a state (e.g., “Armed Stay”) when children return home from school each weekday may be identified. Data associated with such an event may include the identity of the children, the door through which the children return home, the camera that detects the children, the time of day and/or day of the week the children are detected returning home, the action of arming the system “Stay” within a certain amount of time from the arrival of the children at the home, or the like. The pattern may be detected based on one or more of these or other criteria.

At block 706, a notification may be generated based on the identified pattern. For example, a user may be sent a notification suggesting an automation or shortcut be created which allows the system to be set to an “Armed Stay” state in response to detection of the children arriving home. Another example of a notification may be to set a greeting for the children to welcome them home from school in response to detection of their return. Another example may include a notification suggesting setting an alert if the children are not detected returning within a certain time based on a specific time window. The time window may be set by default or suggested based on a detected pattern of variation in the arrival time of the children at the home. In another example, if a particular event is detected, such as leaving for a soccer game each Thursday, the detected pattern may trigger generation of a notification suggesting setting a reminder to be ready and leave for soccer at a certain day/time.

As presented above, the notification may be based on a pattern of user behavior. For example, if the user displays a pattern of searching for a particular event or viewing a particular event, a notification may be provided suggesting setting an alert or other automation corresponding to the frequently searched/viewed event.

At block 708, data may be monitored subsequent to establishment of the pattern. In some embodiments, at block 710, a notification may be generated based on the subsequent data monitored relative to the identified pattern. For example, a notification may be sent reminding the user of garbage day or alerting the user that the garbage was not picked up. As another example, the user may be notified based on a determination that the children have not arrived home from school at the time associated with the pattern. In another example, the user may be notified if an additional person has been detected with the children as they arrive home. While various examples are provided herein, they should be construed as illustrative and not restrictive as it should be appreciated that a wide range and variation of notifications, patterns, and the like are contemplated.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments. These features and advantages of the embodiments will become more fully apparent from the following description and appended claims or may be learned by the practice of embodiments as set forth hereinafter.

As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules to emphasize their implementation independence more particularly. For example, a module may be implemented as a hardware circuit comprising custom very large scale integrated (“VLSI”) circuits or gate arrays, off-the-shelf semiconductor circuits such as logic chips, transistors, or other discrete components. A module may also be implemented in programmable hardware devices such as an FPGA, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules and may be embodied in any suitable for and/organized within any suitable type of data structure. The operational data may be collected as a single data set or may be distributed over different locations including over different storage devices, and may exist, at least partially, merely as electronic signals on a system or network. Where a module or portions of a module are implemented in software, the program code may be stored and/or propagated on in one or more computer-readable medium(s).

The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a server, cloud storage (which may include one or more services in the same or separate locations), a hard disk, a solid state drive (“SSD”), an SD card, a random access memory (“RAM”), a read-only memory (“ROM”), an erasable programmable read-only memory (“EPROM” or Flash memory), a static random access memory (“SRAM”), a Blu-ray disk, a memory stick, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network, a personal area network, a wireless mesh network, and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (“ISA”) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the C programming language or similar programming languages.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods, and computer program products according to various embodiments of the present invention. In this regard, each block in the schematic flowchart diagrams and/or schematic block diagrams may represent a module, segment, or portion of code, which comprises one or more executable instructions of the program code for implementing the specified logical functions.

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

As used herein, a list with a conjunction of and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Means for performing the steps described herein, in various embodiments, may include one or more of a sliding door lock, a sliding door, a window, a network interface, a processor (e.g., a CPU, a processor core, an FPGA or other programmable logic, an ASIC, a controller, a microcontroller, and/or another semiconductor integrated circuit device), an HDMI or other electronic display dongle, a hardware appliance or other hardware device, other logic hardware, and/or other executable code stored on a computer readable storage medium. Other embodiments may include similar or equivalent means for performing the steps described herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

The foregoing method descriptions and the process flow diagrams are provided merely as illustrative examples and are not intended to require or imply that the steps of the various embodiments must be performed in the order presented. As will be appreciated by one of skill in the art the steps in the foregoing embodiments may be performed in any order. Words such as “then,” “next,” etc. are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the principles of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

As utilized herein, the term “substantially” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

While the instant disclosure has been described above according to its preferred embodiments, it can be modified within the spirit and scope of this disclosure. This application is therefore intended to cover any variations, uses, or adaptations of the instant disclosure using the general principles disclosed herein. Further, the instant application is intended to cover such departures from the present disclosure as come within the known or customary practice in the art to which this disclosure pertains.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It is noted that any element disclosed in one embodiment may be incorporated or utilized with any other embodiment disclosed herein.

What is claimed is:

1. A method comprising:
comparing data associated with recorded events;
identifying a pattern in the data;
generating a notification based on the identified pattern;
monitoring data subsequent to identification of the pattern; and
generating an alert based on the monitored data and the identified pattern.

2. The method of claim 1, wherein the pattern in the data is associated with an object detected in the recorded events.

3. The method of claim 1, wherein the pattern in the data is associated with a timing of the recorded events.

4. The method of claim 1, wherein the pattern in the data is associated with a state of an alarm system corresponding to the recorded events.

5. The method of claim 1, wherein the pattern in the data is associated with a user input.

6. The method of claim 1, wherein generating the alert occurs in response to an anomaly in the pattern.

7. The method of claim 1, further comprising confirming the pattern through user input.

8. The method of claim 1, wherein the alert may be generated in response to detection of an anomaly in the pattern.

9. The method of claim 2, wherein the anomaly in the pattern comprises a non-detection event.

10. The method of claim 1, further comprising executing an automated operation based on the monitored data and/or the identified pattern.

11. A system, comprising:
an image capture device;
output devices; and
one or more processors coupled with memory and configured to:
compare data associated with recorded events;
identify a pattern in the data;
generate a notification based on the identified pattern;
monitor data subsequent to identification of the pattern; and
generate an alert based on the monitored data and the identified pattern.

12. The system of claim 11, wherein the pattern in the data is associated with an object detected in the recorded events.

13. The system of claim 11, wherein the pattern in the data is associated with a timing of the recorded events.

14. The system of claim 11, wherein the pattern in the data is associated with a state of an alarm system corresponding to the recorded events.

15. The system of claim 11, wherein the pattern in the data is associated with a user input.

16. The system of claim 11, wherein generating the alert occurs in response to an anomaly in the pattern.

17. The system of claim 11, further comprising confirming the pattern through user input.

18. The system of claim 11, wherein the alert may be generated in response to detection of an anomaly in the pattern.

19. The system of claim 18, wherein the anomaly in the pattern comprises a non-detection event.

20. The system of claim 11, further comprising executing an automated operation based on the monitored data and/or the identified pattern.
